(19) United States
(12) Patent Application Publication
(10) Pub. No.: US 2018/0140387 A1
(43) Pub. Date: May 24, 2018

(54) CONNECTION DEVICE BETWEEN A DENTAL PROSTHESIS AND A MASTER MODEL

(71) Applicant: ANTHOGYR, Sallanches (FR)

(72) Inventor: Hervé RICHARD, Notre Dame de Bellecombe (FR)

(73) Assignee: ANTHOGYR

(21) Appl. No.: 15/570,386

(22) PCT Filed: May 4, 2016
(86) PCT No.: PCT/IB2016/052553

§ 371 Date: Oct. 30, 2017

(30) Foreign Application Priority Data
May 6, 2015 (FR) 1554076

(51) Int. Cl. A61C 8/00; A61C 1/08; A61C 13/103

(52) U.S. Cl. CPC A61C 8/005; A61C 1/084; A61C 13/0004; A61C 13/1009; A61C 8/0001

(57) ABSTRACT

A connection device (1) between a dental prosthesis, or an abutment framework for a dental prosthesis, and a master model, extending longitudinally between a first end (1a) and a second end (1b). The first end (1a) has a first connecting segment (T1) intended to be received in an implant analog, while the second end (1b) has a second connecting segment (T2) intended to be received in the dental prosthesis or the abutment framework. The first connecting segment (T1) has an outer thread (6), while the second connecting segment (T2) has a cylindrical portion (7).

### TECHNICAL FIELD OF THE INVENTION

The present invention relates to the field of dental implantology, in particular the treatment of partial or complete loss of teeth from the dental arch using a single or multiple prosthesis intended to be attached and fixed to one or more dental implants.

A multiple prosthesis is intended to rest on the dental arch of the patient, generally by being fixed to several dental implants that are implanted in the maxillary or mandibular bone of the patient, in order to form several prosthetic teeth. A single prosthesis is intended to rest on the dental arch of the patient, generally by being fixed to a single dental implant that is implanted in the maxillary or mandibular bone of the patient, in order to form a single prosthetic tooth.

Regardless of whether the prosthesis is a single prosthesis or multiple prosthesis, it can be fixed on an implant or implants by way of at least one fixation screw. This screw can be captive or fitted in a cylindrical cavity formed in the prosthesis or formed in an abutment framework for a prosthesis. If necessary, the prosthesis can be withdrawn, for example for repair, by unscrewing the fixation screws.

A known type of prosthesis consists of a prosthesis produced by layering, that is to say by application of several successive layers of materials (such as ceramic, varnish, etc.). This layering is generally carried out using a brush. To ensure that the prosthesis being produced is dimensionally adapted to the jaw of the patient, it is placed on a master model containing at least one implant analog. The master model is a representation of the patient's jaw that is to be restored by means of the prosthesis to be produced. The prosthesis being produced is fixed by screwing in the implant analog, as is illustrated in FIG. 10 of the document US 2003/044753 A1.

The document US 2003/044753 A1 describes a prosthesis which is to be layered and which, together with a post, forms an inseparable assembly. This inseparable assembly can be attached and fixed to an implant analog by means of a fixation screw, of which the stem passes through the post and of which the head presses the post axially against the implant analog. The base of the post has a hexagonal recess receiving a complementary hexagonal cylindrical portion provided at the top of the implant analog. The recess and the cylindrical portion of non-circular shapes cooperate to prevent any rotation of the post with respect to the implant analog, such that the prosthesis is maintained in the correct position, with respect to the adjacent teeth, during the layering.

Between each layer, the prosthesis being produced is passed into the furnace in order to fix the layer of material previously applied.

To avoid oxidation of the one or more screws during each pass into the furnace, it is expedient to withdraw the one or more fixation screws and separate the prosthesis in production from the master model. Oxidation of the screws weakens their mechanical stability and entails a risk of accidental breakage.

However, the withdrawal of the screws proves to be lengthy and awkward to perform without damaging the freshly deposited layer of material. Moreover, the withdrawal of the screws is sometimes impossible when they are held captive in the cylindrical cavity of the prosthesis being produced.

Another type of prosthesis is also known which is composed of a multiple prosthesis comprising an abutment framework. The prosthesis is obtained by adding generic teeth to the abutments of the abutment framework, then by covering the abutment framework and the generic teeth with resin that is injected into a hollow impression, of which the inner shape corresponds to the outer shape of the prosthesis that is to be produced. To ensure that the prosthesis being produced is dimensionally adapted to the jaw of the patient, the abutment framework is placed on a master model containing at least one implant analog. The master model is a representation of the patient's jaw which is to be restored by the prosthesis that is to be produced. The abutment framework is fixed by screwing in said at least one implant analog. During the injection of the resin, the latter covers the abutment framework and part of the generic teeth, while at the same time filling the available volume between the master model and the assembly formed by the abutment framework and the generic teeth.

During the injection of resin, the latter covers the screw heads. Once the resin has solidified, it therefore has to be drilled in order to obtain access to the screw heads, so as to be able to unscrew then with a view to separating the prosthesis from the master model. The location of this drilling is decided somewhat roughly by the prosthetist, who relies on differences in shades (induced by differences in resin thickness) to best estimate the place to start drilling a hole. Withdrawal of the screws once again proves to be a very lengthy procedure.

### DESCRIPTION OF THE INVENTION

A problem addressed by the present invention is to make it easier and quicker to place on the master model, and to remove from the master model, a prosthesis produced by layering or an abutment framework for the production of a prosthesis by injection of resin, while at the same time limiting the risks of accidental damage to the prosthesis.

To achieve these objects and others, the invention proposes a connection device between a dental prosthesis, or an abutment framework for a dental prosthesis, and a master model, extending longitudinally between a first end and a second end in which:
the first end has a first connecting segment intended to be received in an implant analog contained in the master model,
the second end has a second connecting segment intended to be received in the dental prosthesis or the abutment framework for a dental prosthesis,
the first connecting segment has an outer thread intended to be received, by screwing, in an internally threaded segment formed in the implant analog,
the second connecting segment has a cylindrical portion intended to be received by engagement in a corresponding open cylindrical cavity formed in the dental prosthesis or the abutment framework for a dental prosthesis.

Such a connection device permits fixation of the prosthesis (or of the abutment framework) on the master model by a simple engagement which is obtained by a rapid and simple movement of relative translation (or the combination of several) between the prosthesis (or the abutment framework) and the master model. The engagement is reversible, such that the separation of the prosthesis (or of the abutment framework) from the master model is likewise reduced to a rapid and simple movement of relative translation (or the combination of several) between the prosthesis (or the abutment framework) and the master model.

There is no longer any need for screws requiring installation by screwing and removal by unscrewing, which fact greatly accelerates production. Therefore the engagement is done tensioned and produces accordingly a restraint effort of the prosthesis on the master model, said restraint effort being sufficient for the production of the prosthesis (by stratification or coating) but low enough to allow a separation of the prosthesis from the master model without risk of prosthesis degradation.

Preferably, the second connecting segment can have a conical or frustoconical final segment which follows on from the cylindrical portion and of which the cross section decreases away from the first connecting segment. The master model generally has several implant analogs, of which the directions of extension are most often oblique with respect to each other. The conical or frustoconical final segment permits progressive centering of the cylindrical cavities on their respective connection device, with a certain radial play making it possible to compensate for the oblique character of the implant analogs with respect to each other.

Advantageously, the second connecting segment can have at least one radial slit.

Said at least one radial slit, extending longitudinally along the cylindrical portion and, if appropriate, along the conical or frustoconical final segment, makes it possible to confer a certain radial elasticity on the second connecting segment for easy engagement and removal, while at the same time affording a sufficient hold by engagement to avoid accidental separation of the prosthesis (or of the abutment framework) and the master model.

Preferably, to allow it to be fixed by its first end on an implant analog, the connection device can have a screwing socket with a non-circular cross section, accessible from the second end via the cylindrical portion and, if appropriate, via the conical or frustoconical final segment.

Advantageously, the connection device can be produced from a material having a melting point of greater than or equal to 80° C., so as to have a good geometric and mechanical stability during the injection of resin for the production of a prosthesis having an abutment framework.

Good results have been obtained using polyoxymethylene (POM) sold under the brand name Delrin® and having a melting point of about 175° C. Delrin® additionally has good dimensional stability in the normal temperature range of the injected resin.

The connection device according to the present invention allows a dental prosthesis to be received on a master model, said prosthesis having at least one open cylindrical cavity configured to receive the cylindrical portion of the first connecting segment by engagement.

The connection device according to the present invention likewise allows an abutment framework to be received on a master model, said abutment framework having several open cylindrical cavities. It is thus possible to produce a dental prosthesis in the form of a multiple dental prosthesis comprising said abutment framework.

Preferably, the open cylindrical cavity can be configured to receive a fixation screw for fixing the dental prosthesis on a dental implant. The cylindrical cavities already provided in the prosthesis are thus opportunely used to fit the prosthesis on the master model.

According to another aspect, the invention proposes a method for layering a dental prosthesis, characterized in that said method comprises the following steps:
a) making available a master model comprising at least one implant analog with an internally threaded segment,
b) screwing the first end of a connection device as described above in the internally threaded segment of the implant analog,
c) making available a dental prosthesis to be layered, comprising at least one open cylindrical cavity configured to receive the cylindrical portion of the first connecting segment by engagement,
d) displacing the dental prosthesis on the master model by causing the open cylindrical cavity to engage on the cylindrical portion of the second connecting segment by means of a movement of relative translation between the dental prosthesis and the master model,
e) applying at least one layer to the dental prosthesis,
f) withdrawing the dental prosthesis from the master model by means of at least one movement of relative translation between the dental prosthesis and the master model, so as to allow the dental prosthesis to be passed into the furnace without the master model.

Such a method proves very advantageous for limiting the risks of accidental damage and for reducing the production time significantly, especially when:
the master model has a plurality of implant analogs with an internally threaded segment,
the dental prosthesis is of the bridge type and has a plurality of open cylindrical cavities.

According to another aspect, the invention proposes a method for producing a multiple dental prosthesis having an abutment framework, characterized in that said method comprises the following steps:
a1) making available a master model comprising several implant analogs with an internally threaded segment,
b1) screwing the first end of a connection device as described above in the internally threaded segment of several implant analogs,
c1) making available an abutment framework comprising several open cylindrical cavities configured to receive the cylindrical portion of the first connecting segment by engagement,
d1) placing the abutment framework on the master model by causing the open cylindrical cavities to engage on the cylindrical portion of the second connecting segment of the connection devices by means of a movement of relative translation between the abutment framework and the master model,
e1) placing generic teeth and the abutment framework fixed to the master model in a hollow impression corresponding to the outer shape of the dental prosthesis to be produced, the generic teeth then being disposed on the abutments of the abutment framework,
f1) injecting resin between the hollow impression and the master model in such a way as to cover the generic teeth and the abutment framework,
g1) after the resin has solidified, extracting from the hollow impression the assembly which is fixed to the master model and which is formed by the covered generic teeth and abutment framework,
h1) withdrawing the subassembly, formed by the covered generic teeth and abutment framework, from the master model by means of at least one movement of relative translation between said subassembly and the master model.

### BRIEF DESCRIPTION OF THE DRAWINGS

Other subjects, features and advantages of the present invention will become clear from the following description of particular embodiments, with reference being made to the attached figures in which:

FIG. 1 is a perspective view of a first embodiment of a connection device according to the invention;

FIG. 2 is a side view of the connection device from FIG. 1;

FIG. 3 is a side view, in longitudinal section, of the connection device from FIG. 1;

FIG. 4 is a side view, in longitudinal section, of an implant analog equipped with the connection device from FIG. 1;

FIG. 5 is a perspective view of a second embodiment of the connection device according to the invention;

FIG. 6 is a side view of the connection device from FIG. 5;

FIG. 7 is a side view, in longitudinal section, of the connection device from FIG. 5;

FIG. 8 is a side view, in longitudinal section, of an implant analog equipped with the connection device from FIG. 5;

FIG. 9 is a perspective view of a master model comprising a plurality of implant analogs;

FIG. 10 is a perspective view of the master model from FIG. 9 on which several connection devices according to the invention have been attached and fixed;

FIG. 11 is a side view, in section, of the master model from FIG. 9 and of a prosthesis in the course of being produced by layering, before said prosthesis is placed on the master model;

FIG. 12 is a side view, in section, of the master model and of the prosthesis from FIG. 11 when they are joined together to carry out layering;

FIG. 13 is a side view, in section, of the master model from FIG. 9 and of an abutment framework for producing a prosthesis by injection of resin, before the abutment framework is placed on the master model;

FIG. 14 is a side view, in section, of the master model and of the abutment framework from FIG. 13 when they have been joined together;

FIG. 15 is a side view, in section, of the assembled master model and abutment framework from FIG. 13 before their introduction into a hollow impression corresponding to the outer shape of the dental prosthesis to be produced, and with generic teeth; and

FIG. 16 is a side view, in section, of the master model, of the abutment framework, of the hollow impression and of the generic teeth before injection of resin between the impression and the master model.

### DESCRIPTION OF THE PREFERRED EMBODIMENTS

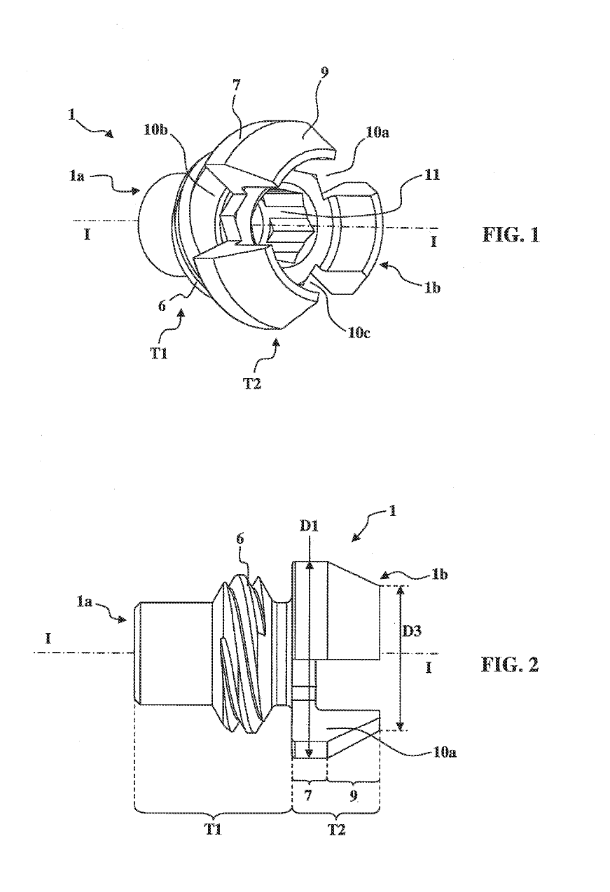

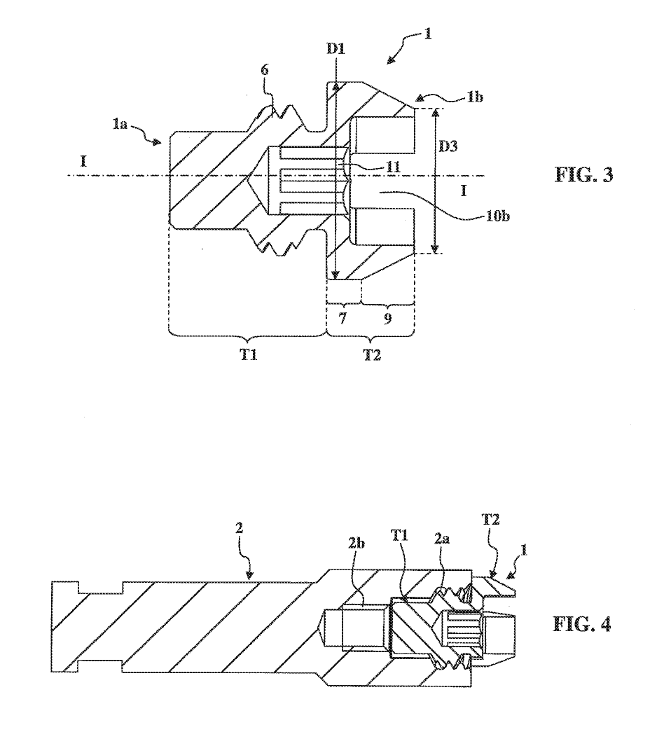

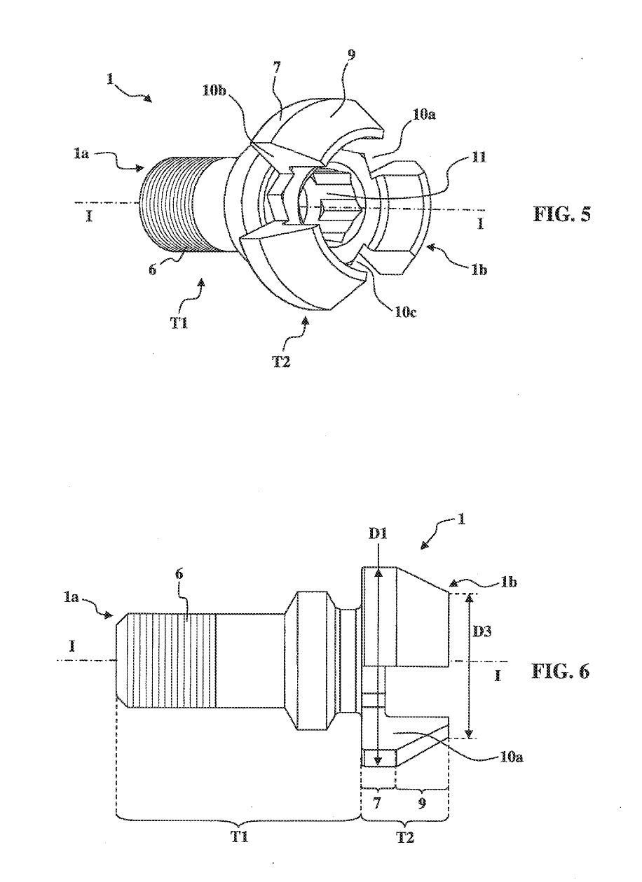

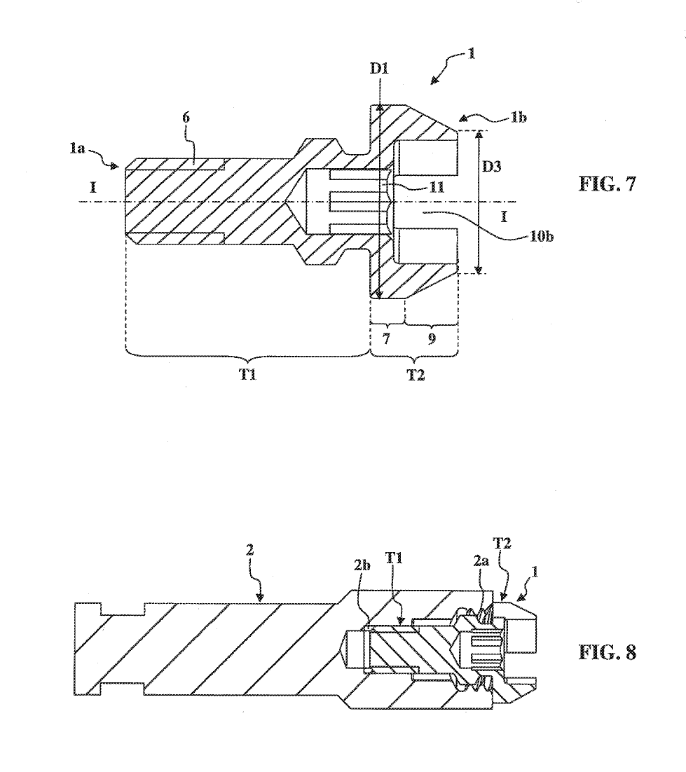

A first embodiment of a connection device 1 according to the invention is illustrated in FIGS. 1 to 4, while a second embodiment is illustrated in FIGS. 5 to 8.

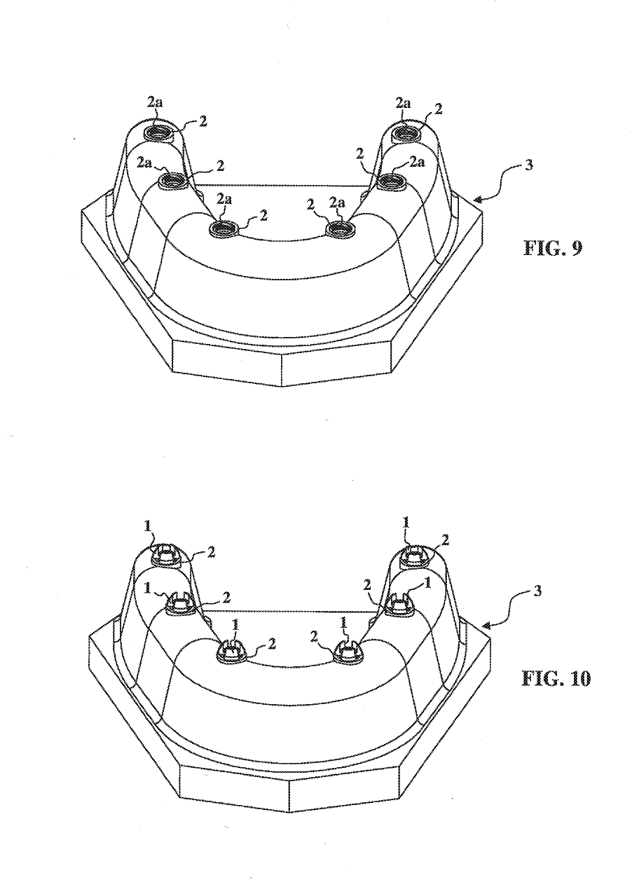

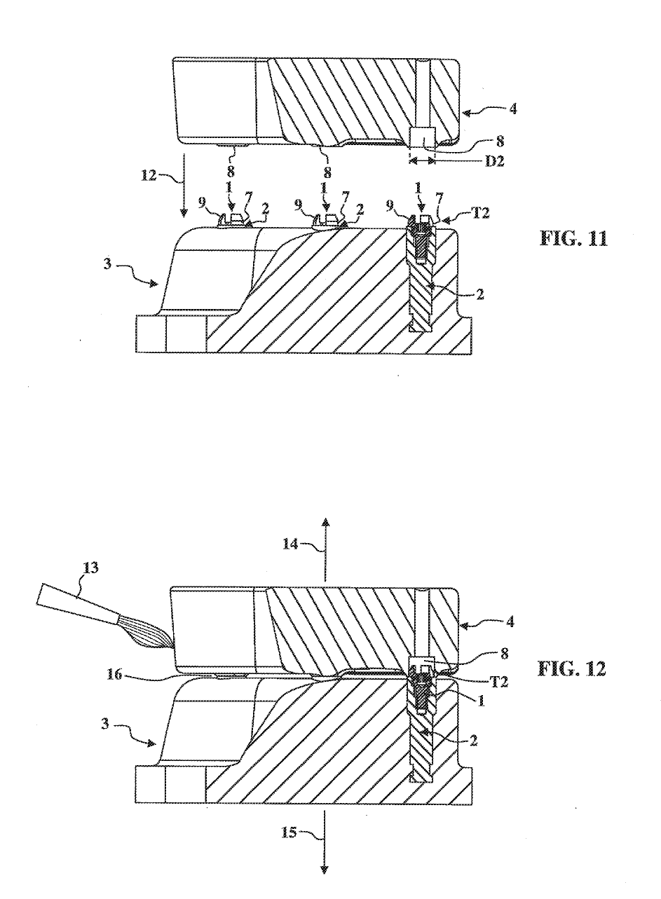

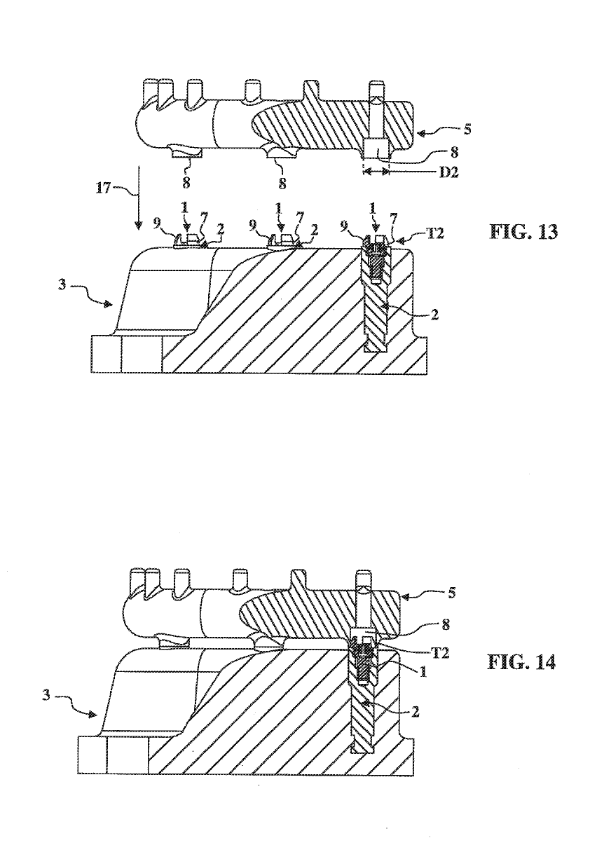

In these figures, the connection device 1 is formed in one piece and extends longitudinally between a first end 1a and a second end 1b in a longitudinal direction I-I. The first end 1a comprises a first connecting segment T1 intended to be received in an implant analog 2 (FIGS. 4 and 8) contained in a master model 3 (FIG. 9). The second end 1b comprises a second connecting segment T2 intended to be received in a dental prosthesis 4 (FIG. 11) or in an abutment framework 5 for a dental prosthesis (FIG. 13).

The first connecting segment T1 has an outer thread 6 intended to be received by screwing in an internally threaded segment 2a or 2b formed in the implant analog 2 (FIGS. 4 and 8).

The second connecting segment T2 comprises a cylindrical portion 7 intended to be received by engagement in an open cylindrical cavity 8 formed in the dental prosthesis 4 (FIG. 11) or in the abutment framework 5 for a dental prosthesis (FIG. 13).

The second connecting segment T2 has a frustoconical (or conical) final segment 9 following on from the cylindrical portion 7. The cross section of the frustoconical final segment 9 decreases away from the first connecting segment T1.

The second connecting segment T2 has three radial slits 10a to 10c extending longitudinally along the cylindrical portion 7 and along the frustoconical final segment 9.

As will be seen more particularly in FIGS. 1, 3, 5 and 7, the connection device 1 has a screwing socket 11 with a non-circular cross section (hexagonal in this case). This screwing socket 11 is accessible from the second end 1b via the cylindrical portion 7 and the frustoconical final segment 9. The connection device in FIGS. 1 to 4 differs from the connection device 1 in FIGS. 5 to 8 in terms of the location of the outer thread 6.

The cylindrical portion 7 has a circular cross section with a diameter D1 slightly greater than or equal to the diameter D2 of the cylindrical cavity 8 provided in the dental prosthesis 4 (FIG. 11) or in the abutment framework 5 for a dental prosthesis (FIG. 13). The cylindrical portion 7 is thus able to engage with a slight force in the cylindrical cavity 8.

The radial slits 10a to 10c impart a degree of radial compressibility to the cylindrical portion 7, so as to promote the engagement of the latter with force in the cylindrical cavity 8.

The frustoconical final segment 9 ends with a diameter D3 smaller than the diameter D2 of the cylindrical cavity 8. The frustoconical final segment 9 thus engages easily in the cylindrical cavity 8 and allows the cylindrical cavity 8 to be pre-centered with respect to the cylindrical portion 7 before the cylindrical cavity 8 is engaged with force on the cylindrical portion 7.

The open cylindrical cavity 8 of the dental prosthesis 4 (FIG. 11) or of the abutment framework 5 for a dental prosthesis (FIG. 13) is configured to receive a fixation screw for fixing the dental prosthesis on a dental implant fitted in the mouth of the patient. The present invention thus makes double use of the cylindrical cavity 8 by using it firstly for fixing on a master model 3 (FIG. 9) and then for fixing in the mouth of the patient.

It should be noted that, in the figures, the cylindrical cavity 8 is shown in a simplified manner so as not to inhibit the reader's understanding. In practice, it may for example comprise an internal annular groove for receiving an elastic ring (circlip) intended to serve as a seat under the screw head.

The use of a connection device 1 according to the invention during a method of layering a dental prosthesis 4 is illustrated in FIGS. 9 to 12.

During this method, a master model 3 (FIG. 9) is made available comprising at least one implant analog 2 as illustrated, in FIGS. 4 and 8 (step a)). Here, the master model 3 comprises six implant analogs 2, each with an internally threaded segment 2a and/or 2b.

The practitioner then screws the first end 1a of six connection devices 1 into the internally threaded segment 2a or 2b of the implant analogs 2. If the practitioner uses connection devices 1 such as the one illustrated in FIGS. 1 to 3, the connection device is screwed into the internally threaded segment 2a of the implant analogs 2. By contrast, when he uses connection devices 1 like the one illustrated in FIGS. 5 to 7, the connection devices 1 are screwed into the internally threaded segment 2b of the implant analogs 2.

During the connection by screwing, the practitioner drives the connection devices 1 in rotation by means of a screwing tool with a hexagonal shape matching the screwing socket 11.

At the end of this connection step (step b)), the master model 3 is situated in the configuration shown in FIG. 10.

During a step c), a dental prosthesis 4 to be layered is made available, such as the one illustrated in FIG. 11, having as many open cylindrical cavities 8 as the master model 3 has implant analogs 2. The cylindrical cavities 8 are provided in the prosthesis 4 in exact alignment with the implant analogs 2. It will be noted here that the implant analogs 2 can be oriented obliquely with respect to each other in order to meet implantation requirements deemed necessary by the practitioner. In FIGS. 9 to 12, the implant analogs 2 have been shown oriented in directions of extension that are parallel to each other, but only in order to facilitate the reader's understanding.

The dental prosthesis 4 is of the bridge type and has a plurality of open cylindrical cavities 8 configured to receive a fixation screw for fixing the dental prosthesis 4 on dental implants disposed in the mouth of the patient.

During a step d), the dental prosthesis 4 is placed on the master model 3 by means of a movement of relative translation (arrow 12 in FIG. 11) between the dental prosthesis 4 and the master model 3. This causes the open cylindrical cavity 8 to engage on the cylindrical portions 7 of the connection devices 1.

During this step, the frustoconical final portions 9 provide a pre-centering of the cylindrical cavities 8 with respect to the cylindrical portions 7. This is all the more useful when the implant analogs 2 are oriented in oblique directions.

It will be noted that the relative movement between the dental prosthesis 4 and the master model 3 can comprise more than one translation when the implant analogs 2 are oriented obliquely with respect to each other. The main movement remains a movement of relative translation as illustrated by the arrow 12 in FIG. 11, the other movements of translation being generally induced by the engagements of the cylindrical cavities 8 on the frustoconical final segments 9 and cylindrical portions 7 when the movement of translation 12 reaches its conclusion.

The configuration as illustrated in FIG. 12 is reached at the end of this placement of the dental prosthesis 4 on the master model 3. Thereafter, during a step e), at least one layer can be applied to the dental prosthesis 4 with the aid of a brush 13, for example. No fixation by screws is necessary.

Once the layering is completed, the practitioner withdraws the dental prosthesis 4 from the master model 3 by means of a movement of relative translation between the dental prosthesis 4 and the master model 3 as illustrated by the arrows 14 and 15. To do this, the practitioner can insert a tool into the residual space 16 situated between the dental prosthesis 4 and the master model 3 in order to provide leverage and cause a separation of the dental prosthesis 4 and of the master model 3, which leads to removal of the cylindrical portions 7 of the connection devices 1 from the cylindrical cavities 8.

During this withdrawal step (step f)), the connection devices 1 remain integral with the master model 3 by virtue of their screwed connection. Another type of connection may nevertheless be used, such as a connection involving an interference fit (for example by means of bayonets), as long as this type of connection affords a retention of the connection devices 1 in the implant analogs 2 that is greater than the engaged connection of the cylindrical cavities 8 on the cylindrical portions 7.

At the end of the withdrawal step, the dental prosthesis can be passed into a furnace in order to fix the layer that has been applied during the step e).

The connection device 1 according to the invention can likewise be used in a method for producing a multiple dental prosthesis comprising a abutment framework 5. Such a method is illustrated in FIGS. 9, 10 and 13 to 16.

During a step a1), a master model 3 (FIG. 9) is made available that comprises several implant analogs 2 with an internally threaded segment 2a and/or 2b.

During a step b1), the first end 1a of the connection device 1 according to the invention is screwed into the internally threaded segment 2a or 2b of the implant analogs 2 (FIG. 10).

During a step c1), an abutment framework 5 (FIG. 13) is made available that comprises several open cylindrical cavities 8. The open cylindrical cavities 8 are configured to receive a fixation screw for fixing the dental prosthesis on dental implants provided in the mouth of the patient.

During a step d1), the abutment framework 5 is placed on the master model 3 by causing the open cylindrical cavities 8 to engage on the cylindrical portion 7 of the connection devices 1. To do this, a movement of relative translation (arrow 17 in FIG. 13) is applied between the abutment framework 5 and the master model 3. Here too, more than one translation may be needed depending on the degrees of inclination of the implant analogs 2 relative to each other.

The configuration illustrated in FIG. 14 is thereby reached, in which the abutment framework 5 rests on the implant analogs 2 of the master model 3 and is held in place there by the connection devices 1 engaging in the cylindrical cavities 8. Here too, no screw fixation is needed.

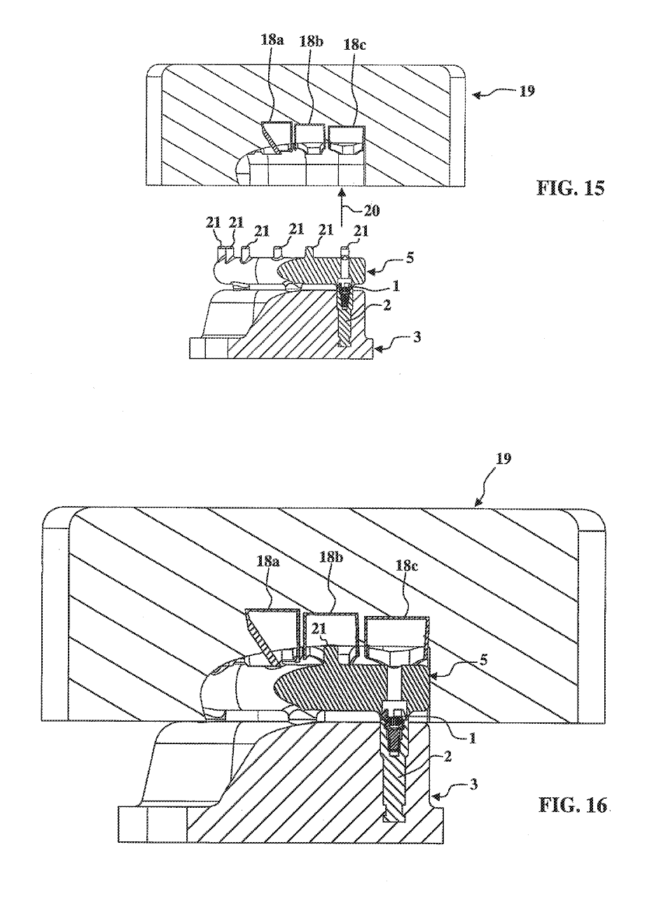

Thereafter, during a step e1), the practitioner attaches generic teeth 18a to 18c in a hollow impression 19 corresponding to the outer shape of the dental prosthesis that is to be produced. The abutment framework 5 is then inserted into the hollow impression 19 according to the movement of translation illustrated by the arrow 20 (FIG. 15), causing each abutment 21 to engage in its corresponding generic tooth 18a to 18c.

This then results in the configuration illustrated in FIG. 16.

During a step f1), resin is injected between the hollow impression 19 and the master model 3 in such a way as to cover the generic teeth 18a to 18c and the abutment framework 5. A dental prosthesis is thus obtained which, on one side, matches the dental prosthesis outline by virtue of the hollow impression 19 and, on the other side, conforms to the patient's jaw (on which the prosthesis is to be implanted) by virtue of the master model 3.

After the resin has solidified, the assembly fixed to the master model 3 and formed by the covered generic teeth 18a to 18c and the covered abutment framework 5 is extracted (during a step g1)) from the hollow impression 19.

Finally, during a step h1), the subassembly formed by the covered generic teeth 18a to 18c and the covered abutment framework 5 is withdrawn from the master model 3 by means of a movement of relative translation between said subassembly and the master model 3. This movement of translation can be effected by leverage with the aid of a component that the practitioner inserts between the subassembly, formed by the generic teeth 18a to 18c and the abutment framework 5, and the master model 3.

Whether for the production of a dental prosthesis 4 by layering or for the production of a dental prosthesis by injection of resin, the connection device 1 according to the invention allows a prosthesis 4 being layered or an abutment framework 5 to be attached and fixed with a satisfactory hold on the master model 3, without having to use screws which considerably lengthen the time the practitioner needs to complete the work. Moreover, the withdrawal of the master model 3 from the layered prosthesis 4, for passing the latter into the furnace, or of the subassembly formed by the generic teeth 18a to 13c and the abutment framework 5, is easy and quick for the practitioner to do.

The present invention is not limited to the embodiments that have been explicitly described, and instead it includes the different variants and generalizations contained within the scope of the below claims.

1-10. (canceled)

11. A connection device between a dental prosthesis, or an abutment framework for a dental prosthesis, and a master model, extending longitudinally between a first end and a second end, wherein:
the first end has a first connecting segment intended to be received in an implant analog contained in the master model,
the second end has a second connecting segment intended to be received in the dental prosthesis or the abutment framework for a dental prosthesis,
the first connecting segment has an outer thread intended to be received, by screwing, in an internally threaded segment formed in the implant analog,
the second connecting segment has a cylindrical portion intended to be received by engagement in a corresponding open cylindrical cavity formed in the dental prosthesis or the abutment framework for a dental prosthesis.

12. The connection device as claimed in claim 11, wherein the second connecting segment has a conical or frustoconical final segment which follows on from the cylindrical portion and of which the cross section decreases away from the first connecting segment.

13. The connection device as claimed in claim 11, wherein the second connecting segment has at least one radial slit.

14. The connection device as claimed in claim 11, having a screwing socket with a non-circular cross section, accessible from the second end via the cylindrical portion and, if appropriate, via the conical or frustoconical final segment.

15. The connection device as claimed in claim 11, wherein it is produced from a material having a melting point of greater than or equal to 80° C.

16. A method for layering a dental prosthesis, wherein said method comprises the following steps:
a) making available a master model comprising at least one implant analog with an internally threaded segment,
b) screwing the first end of a connection device as claimed in claim 11 in the internally threaded segment of the implant analog,
c) making available a dental prosthesis to be layered, comprising at least one open cylindrical cavity configured to receive the cylindrical portion of the first connecting segment by engagement,
d) placing the dental prosthesis on the master model by causing the open cylindrical cavity to engage on the cylindrical portion of the second connecting segment by means of a movement of relative translation between the dental prosthesis and the master model,
e) applying at least one layer to the dental prosthesis,
f) withdrawing the dental prosthesis from the master model by means of at least one movement of relative translation between the dental prosthesis and the master model, so as to allow the dental prosthesis to be passed into the furnace without the master model.

17. The layering method as claimed in claim 16, wherein:
the master model has a plurality of implant analogs with an internally threaded segment,
the dental prosthesis is of the bridge type and has a plurality of open cylindrical cavities.

18. The layering method as claimed in claim 16, wherein the open cylindrical cavity is configured to receive a fixation screw for fixing the dental prosthesis on a dental implant.

19. A method for producing a multiple dental prosthesis having an abutment framework, wherein said method comprises the following steps:
a1) making available a master model comprising several implant analogs with an internally threaded segment,
b1) screwing the first end of a connection device as claimed in claim 11 in the internally threaded segment of several implant analogs,
c1) making available an abutment framework comprising several open cylindrical cavities configured to receive the cylindrical portion of the first connecting segment by engagement,
d1) placing the abutment framework on the master model by causing the open cylindrical cavities to engage on the cylindrical portion of the second connecting segment of the connection devices by means of a movement of relative translation between the abutment framework and the master model,
e1) placing generic teeth and the abutment framework fixed to the master model in a hollow impression corresponding to the outer shape of the dental prosthesis to be produced, the generic teeth then being disposed on the abutments of the abutment framework,
f1) injecting resin between the hollow impression and the master model in such a way as to cover the generic teeth and the abutment framework,
g1) after the resin has solidified, extracting from the hollow impression the assembly which is fixed to the master model and which is formed by the covered generic teeth and abutment framework,
h1) withdrawing the subassembly, formed by the covered generic teeth and abutment framework, from the master model by means of at least one movement of relative translation between said subassembly and the master model.

20. The manufacture method as claimed in claim 19, wherein the open cylindrical cavities are configured to receive a fixation screw for fixing the dental prosthesis on a dental implant.
